(19) United States
(12) Patent Application Publication
(10) Pub. No.: US 2019/0317942 A1
(43) Pub. Date: Oct. 17, 2019

(54) System and Method for Evaluation of Applications

(71) Applicant: Jinfeng Zhang, Tallahassee, FL (US)

(72) Inventor: Jinfeng Zhang, Tallahassee, FL (US)

(21) Appl. No.: 16/387,476

(22) Filed: Apr. 17, 2019

Related U.S. Application Data
(60) Provisional application No. 62/658,629, filed on Apr. 17, 2018.

(51) Int. Cl. G06F 16/2457; G06F 16/906; G06F 16/9035; G06F 16/93

(52) U.S. Cl. CPC G06F 16/24578; G06F 16/93; G06F 16/9035; G06F 16/906

(57) ABSTRACT

The present invention is a computer-implemented method in a server system for evaluating a number of submissions provided by a number of applicants. The method groups the submissions into subgroups which are then assigned to each applicant. Each applicant ranks the subgroup that they are provided from best to worse. A score is calculating based on the rankings by all applicants. That score is used to calculate an initial global ranking which can be compared to the rankings of specific pairs of submissions within each subgroup to determine the accuracy of the global ranking overall. If inaccurate, the specific pairs can be adjusted to increase the accuracy of the global ranking.

### CROSS-REFERENCES TO RELATED APPLICATIONS

Pursuant to the provisions of 37 C.F.R. § 1.53(c), this non-provisional application claims the benefit of an earlier-filed provisional patent application. The earlier application was assigned U.S. Ser. No. 62/658,629. It lists the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates to the field of a computer-implemented method to evaluate applications. More specifically, the present invention comprises a method and system for allowing a number of reviewers to accurately evaluate and rank applications or submissions of any kind.

### 2. Description of the Related Art

Scholarly research assessment plays an indispensable role in many aspects of scientific research. From the most fundamental level of research itself, scientific outcomes need to be evaluated before being published in peer-reviewed journals. Publication record is one of the most important factors in grant proposal evaluations. Publication and grant records are then used to evaluate individual scientists in most research-oriented academic programs, departments and institutions, together with other factors such as teaching and service. At higher levels, research-oriented academic programs, departments and institutions are evaluated by more complex criteria where publications, grants and the quality of their faculty are key factors in the overall metric.

FIG. 1 shows the relationships among scientists, their research discoveries, publications, grants and research programs/departments/institutions. This figure illustrates that that quality of manuscript and grant proposal evaluation affects the overall scholarly research assessment at every level from publications and grant proposal evaluation themselves, to individual scientists, to programs/departments/institutions.

There are two key components in any scholarly research assessment (or any assessment in general): the metric (or criteria) for measuring quality and the approach to obtain the values of the corresponding metric for the subjects to be evaluated. For scientific publications, the most commonly used criteria include the significance of the research, the contribution of the results to existing knowledge, the novelty and the validity of the method, and the presentation (writing). For grant proposals, the common criteria include significance, novelty and validity of the approach, preliminary results, responsiveness to funding program (fitness), the expertise of the investigators, and institutional support. Additional criteria are imposed by specific agencies. For example, National Science Foundation (“NSF”) has the broader impact criterion in addition to intellectual merits.

There are various approaches to obtaining the values for a given metric. All approaches utilize human experts (or peers) to assign a value to each criterion in the metric. The number of expert utilized by each approach varies. For example, peer-reviewed scientific articles are typically evaluated by a small number of experts (2-4) in the relevant research area. However, the small number of experts are often overwhelmed with the number of submissions. Additionally, where only a small number of reviewers are evaluating an article, the bias of a single reviewer can significantly affect the outcome of the evaluation. On the other hand, where many experts are used to review research/proposals it can be expensive and difficult to create a uniform ranking system.

Therefore, what is needed is a system and method to improve the quality of the reviewing process while substantially reducing the review costs. The present invention method achieves this objective, as well as others that are explained in the following description.

### BRIEF DESCRIPTION OF THE SEVERAL VIEWS OF THE DRAWINGS

FIG. 1 is a diagram, showing the relationship and interaction between research, scientists and institutions.

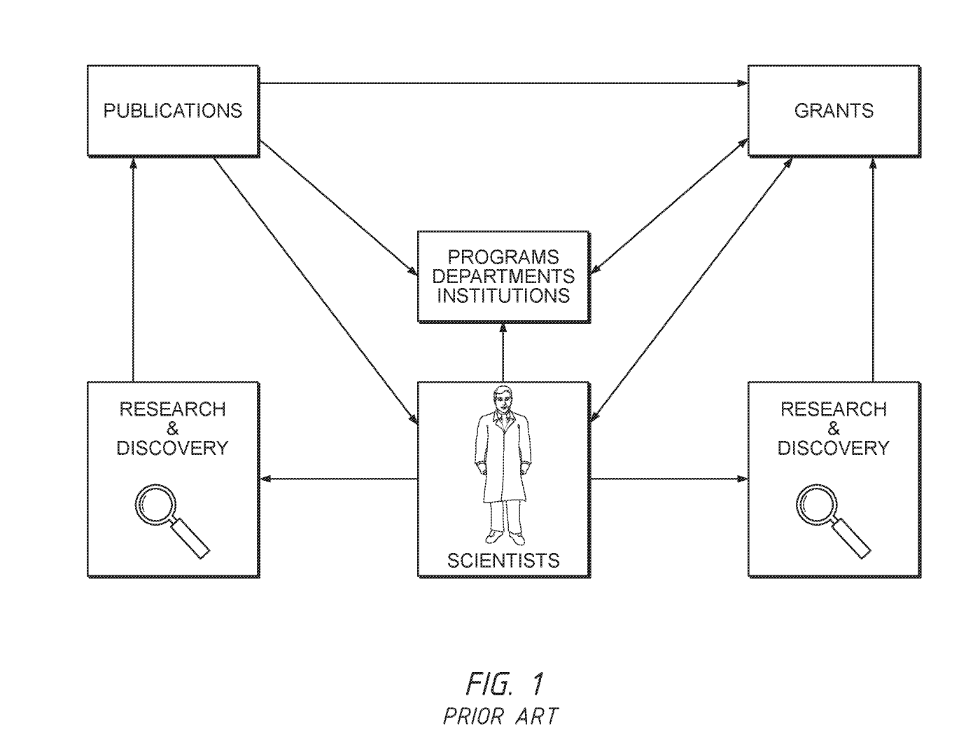

FIG. 2 is a diagram, showing the MBC scoring process as used in the current method.

FIG. 3 is a diagram, showing the CI value and process of current method.

FIG. 4 is a diagram, showing the multi-step process of the current method.

FIG. 5 is a flow chart, showing the present method.

FIG. 6 is a block diagram showing an embodiment of the present invention.

### REFERENCE NUMERALS IN THE DRAWINGS

| | | | |
|---|---|---|---|
| 10 | present method | 12 | server |
| 14 | first database | 16 | server engine |
| 18 | internet connection | 20 | computing device |
| 22 | browser | | |

### DETAILED DESCRIPTION OF THE INVENTION

The present invention is a computer-implemented system and method for the effective evaluation of numerous submissions (applications, articles, grant proposals, etc). The method allows an administrator to manage the review of numerous submissions by assigning individuals to evaluate the submissions. In one embodiment the applicants themselves act as the evaluators. The system improves the accuracy and efficiency of the evaluation process.

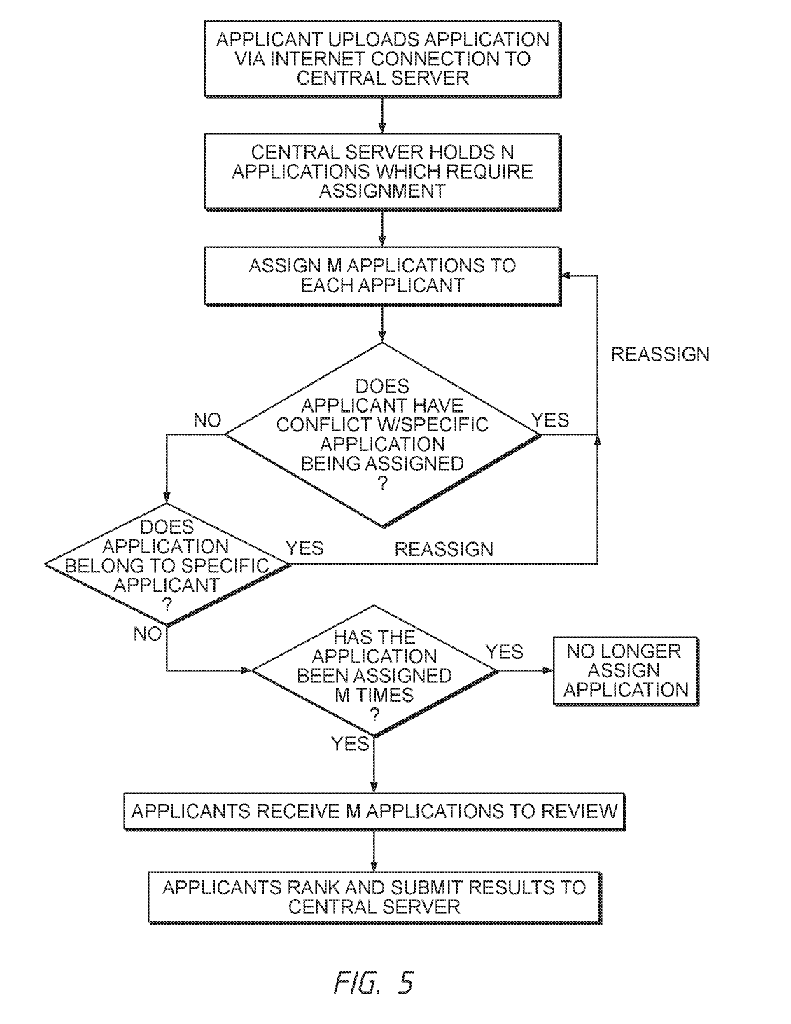

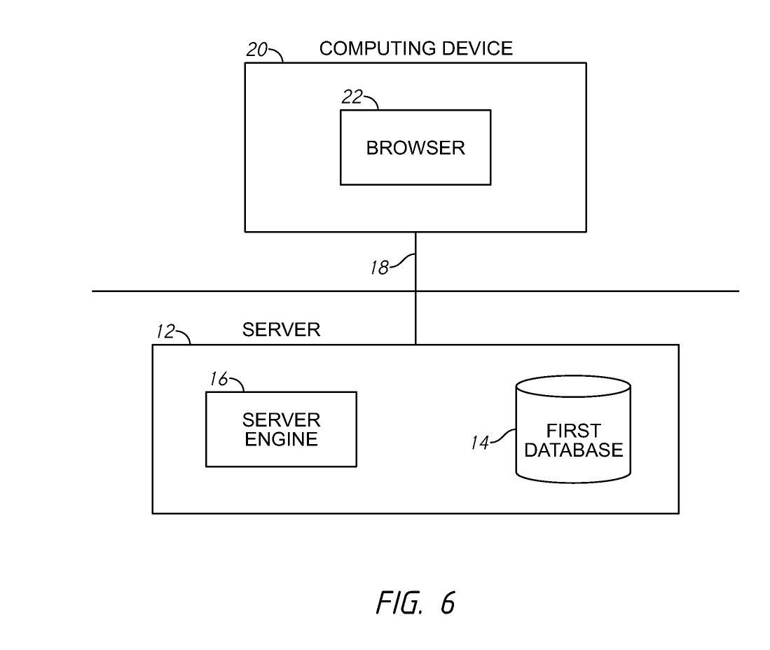

In one embodiment, illustrated in FIGS. 5 and 6 applicants, via a computing device 20 and web browser 22, upload a submission including associated keywords to a server 12 system. The applicant also lists any conflicts of interest. The server 12 system stores the applicant information in a first database 14 and the submissions themselves. After all submissions are uploaded, the administrator, via a computing device 20, identifies a certain number of submissions (sub-group) to assign to each applicant. That number is identical to the number of times a submission will be reviewed. For example, if 3 submissions are assigned to each applicant, each submission in the system will be reviewed by 3 separate applicants. Next, the system (or server engine 16 in one instance) matches applicants with specific submissions based on several factors. The system (server engine 16) will not assign a submission to an applicant that is a conflict of interest, nor will the system assign the applicant's own submission to that applicant. Additionally, once a submission has been assigned to a set number of applicants that submission will no longer be included in the pool of submissions to assign.

Once the applicants receive their sub-groups of m applications, they will review and rank the submissions within their sub-group, along with providing other feedback. No two applicants are given an identical sub-group of submissions. Therefore, each submission is compared within several different sub-groups. The present method evaluates the rankings and creates a concordance index (“CI”) based on the rankings presented by all applicants. Additionally, an overall initial global ranking is created by utilizing a modified Borda count (“MBC'). The present method improves the accuracy of the global ranking by comparing the initial MBC-based global ranking with the CI of individual pairings, as further described herein. Once the most accurate global ranking is obtained the administrator can opt to utilize the global rankings to make a decision about what submissions to accept or reject or can opt to engage in additional steps to improve the reliability of the rankings, such as narrowing the field and running a second evaluation.

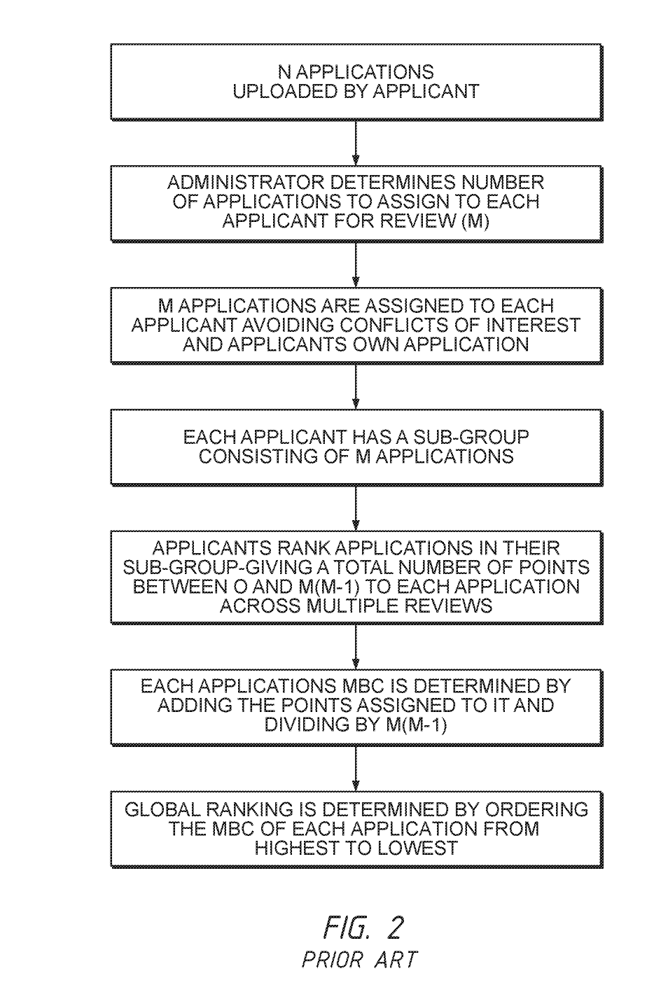

FIG. 2 illustrates the initial steps of the present method in the preferred embodiment. A number (n) of applications are uploaded to a central server 12 by applicants. The reader will appreciate that the term application is being utilized to represent any type of submission that requires evaluation. For example, the application could represent a grant proposal, research, articles, art works, papers or any other item that requires review. Similarly, the term applicant is used throughout to indicate the individual performing the evaluation of other applications. It should be noted that while an applicant who applied for review is desirable, the method should not be limited to utilizing an individual who applied. In some instances, a group of independent experts could be utilized to affect the review.

An administrator or evaluator, accessing the submissions in the central server 12 via a computing device, determines when all applications are ready to be assigned. The administrator is the individual or group in charge of managing the evaluation of applications. The administrator may set a deadline for submission and accept all applications that meet minimum requirements submitted prior to the deadline. On the other hand, the administrator may set a specific number of submissions and decline to accept any applications after the set number of applications is reached. The present method works with any number of applications. Once all applications are submitted, a set number of applications (M) are assigned to each applicant for review. Prior to being assigned to an applicant, the application is checked to ensure that the application being assigned does not belong to the applicant and that the application does not present a conflict of interest. Once each application has been assigned to M applicants, each applicant will have a sub-group consisting of M applications. Next Applicants rank the applications within their own sub-group, giving a total number of points between 0 and M(M-1) to each application across multiple reviews. For example, if an applicant was assigned and ranked five applications (A, B, C, D and E) in that order from best to worst, A would be given 4 points, B—3 points, C—2 points, D—1 point and E—0 points. Since each application receives M reviews the total score for that application must lie between 0 and M(M-1). The MBC score is the total score that the application receives divided by the total number of points possible (M(M-1)). Applications can then be ranked in accordance with their total MBC scores. While reviewers are discouraged from tie rankings, it is possible to rank two applications the same. Note that each reviewer has a fixed number of points to assign, therefore two applications can be assigned an equal number of points, while maintaining the constant total number of points. For example, suppose a reviewer feels that applications B and C are tied, the reviewer could assign A—4, B—2.5, C—2.5, D—1 and E—0. The MBC total score for each application determines the initial MBC global ranking for the present method.

The present method promotes diligence and honesty where applicants themselves are acting as the reviewers by giving the applicants a bonus for accurately ranking the applications. To measure the accuracy, the absolute deviation of the reviewer's ranking from the global ranking is calculated. For example, suppose the global ranking is A_{g}(4), B_{g}(3), C_{g}(2), D_{g}(1), E_{g}(0) and suppose reviewer N provides a ranking of D_{N}(4), A_{N}(3), E_{N}(2), B_{N}(1), C_{N}(0). The quality index for this ranking would be Q_{N}=|A_{g}−A_{N}|+|B_{g}−B_{N}|+|C_{g}−C_{N}|+|D_{g}−D_{N}|+|E_{g}−E_{N}|=1+2+2+3+2=10. Perfect agreement would yield a value of Q=0. Thus, lower scores are more desirable. Note that a ranking that is precisely the opposite of the global ranking would yield the maximum score or in the present example Qmax=12.

The incentivized ranking is then obtained. To begin, each application is given a score based on its rank, with a higher score representing a higher rank. With the example above, A, B, C, D, E, the scores would be SA>SB>SC>SD>SE. Given these scores the average difference in score between adjacently ranked applications is A=(Smax−Smin)/n, where n is the total number of applications. To each of these scores will be added a bonus score computed as B(N)=2A (Qmax−Q(N))/Qmax. Thus, if reviewer N submitted application C, the resulting score for application C would be SC+B(N). The final ranking of applications could then be based on incentivized scores.

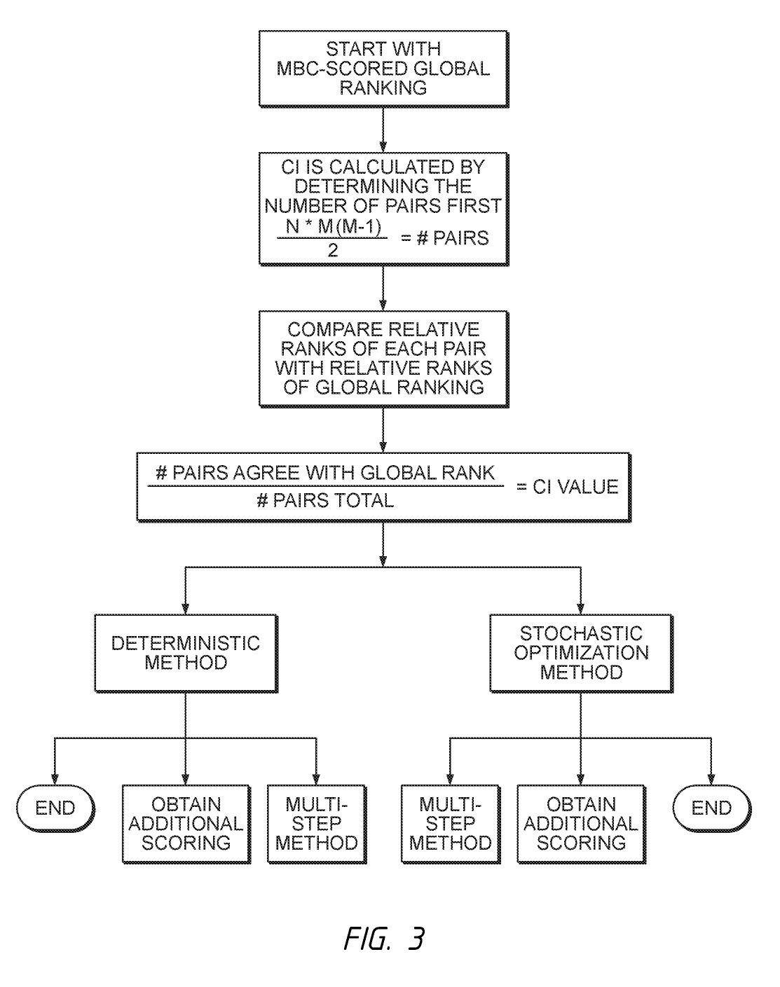

The present method improves upon the MBC global ranking by incorporating a concordance index based global ranking (CIGR). The concept of concordance index (CI) is used to quantify the quality of rankings and is illustrated in FIG. 3. Here, the present method compares the individual pairings of applications to the global ranking to determine the CI. The higher the CI, the better the agreement between the final ranking and the ranks provided by the applicants.

The CI values in the present method are calculated as follows. Given a global ranking of n applications with each applicant reviewing m applications, the ranking of m applications by each applicant will give relative ranks for m(m-1)/2 application pairs. The total number of pairs from all applicants is n*m(m-1)/2, with the possibility that some pairs may occur more than once. The relative ranks of the n*m(m-1)/2 pairs provided by the applicant with the relative ranks of the corresponding proposal pairs in a given global ranking (how the global ranking is obtained will be described later). The fractions of the pairs that both agree is the concordance index value for the global ranking. Table 1 below provides an exemplary illustration. The example assumes 6 applications with the 1st ranking the best and the 6th ranking the worst. The example also assumes that the applicants do a perfect job in ranking the applications assigned to them.

TABLE 1

| | Three applications assigned | MBC score of applications |
|---|---|---|
| Applicant | to each applicant | of each Applicant |
| A | D, E, F | 1 |
| B | A, C, D | 5/6 |
| C | B, E, F | 1/3 |
| D | A, B, C | 1/2 |
| E | A, D, F | 1/3 |
| F | B, C, E | 0 |

As shown in Table 1, each applicant reviews and ranks three applications. The MBC is calculated to determine the initial global ranking of the applications. In this case, the MBC for application A is 1, or the highest possible MBC score. As seen in column 2, A is ranked by applicant B, D and E. Each applicant ranked A as the top application, awarding it 2 points. Therefore, A was awarded a total of 6 points. Because the total possible points are also 6, A has an MBC score of 6/6 or 1. Similarly, B is ranked by C, D and F and is awarded 2+1+2 points respectively. B therefore has an MBC of 5/6 and is ranked 2nd globally. D is ranked third globally. D is ranked by A, B and E and is awarded 2+0+1 points respectively. D therefore has an MBC score of ½. C and E both receive an MBC score of 2/6 or 1/3rd. Therefore, C and E tie for 4th place. F receives an MBC score of 0 and is ranked in 6th place globally.

The MBC score global ranking is: A, B, D, C-E, F. The reader will appreciate that although application D ranked in the third position, it was only ranked in that position because D had the benefit of being compared to three “lesser” applications (E, F, F) while application C was only compared to two “lesser” applications (D, E). Therefore, the sole reason D out-performed C was due to the assignment of applications rather than actually being ranked higher than C by the evaluators. In fact, C was ranked higher than D by the head-to-head comparison (row 2), which provides valuable information about each application's merit. The global ranking therefore contradicts the true ranking by the applicants, when comparing the individual pairs of certain applications (e.g. C-D). This example illustrates that an evaluation based on the MBC scores alone provides a less than accurate global ranking.

The present method is able to use the concordance index to modify the global ranking in “concordance” with the rankings of the individual pairs. A global ranking that has the highest CI value of 1 totally agrees with the true ranking. The ranking obtained using MBC in the present example has a CI value of 17/18 (17 out of 18 pairs provided by the applicants agree with the MBC global ranking). Each applicant's rankings include three pairs. Therefore, with 6 applicants there are 18 pairs to evaluate. In this example, the head-to-head comparison (or pairing) wherein C was ranked higher than D by applicant B is the only pair that does not agree with the MBC global ranking. If the CI value is 1 than the MBC global ranking is accurate, and the evaluation can end. However, where the CI value is less than 1, it is desirable to improve upon the MBC obtained global ranking. In order to do so, there are two embodiments of the present method which search the global ranking with optimal CI values. Because both embodiments start from the global ranking obtained using MBC scores, they guarantee that either the same or better global rankings will be generated than the MBC based method.

The first embodiment is the deterministic (or greedy) method. The MBC global ranking (initial global ranking) is the starting point. The conflicts of the global ranking with the ranks provided by the applicants are evaluated first. In calculating the CI, some application pairs may agree between two rankings, and some pairs may incur multiple conflicts. For example, the relative rank in a global ranking between two applications, A and B, is that A ranks higher than B. Multiple applicants may review both A and B together and may have different relative ranks for the pair. Switching A and B will give a new global ranking, which may have different CI value. In the greedy embodiment, the pair that will increase CI value the most will be switched first. After the switch the CI value is recalculated for the changes in all the pairs affect by this switch. In a case where several pairs have the same CI value change, the pair that has the highest ranking will be switched (it is always preferable to rank higher quality applications more accurately). This process repeats until no further improvement can be made. In the example shown in Table 1 above, if D is switched with C, so that the new global ranking is A, B, C, D, E, F, the CI value would increase to 18/18 or 1 (because all 18 pairings agree with the new global ranking). Because the CI value increased with the switch, the new ranking would be kept and ultimately, the ranking would be more accurate (more aligned with the actual rankings by the applicants).

The second embodiment is the stochastic optimization method. Again, the starting point for the method is the MBC global ranking. The stochastic optimization method utilizes a method based on Metropolis-Hastings algorithm, a classic Monte Carlo simulation technique. A random pair will be selected and switched. If the move improves the CI value, then the move will be accepted and the ranking changed. If the move does not improve the CI value, then it will be accepted according to a probability that is correlated with how good the move is. The optimization will be run for a pre-determined number of times. The best global ranking obtained in the optimization will be used as the final global ranking.

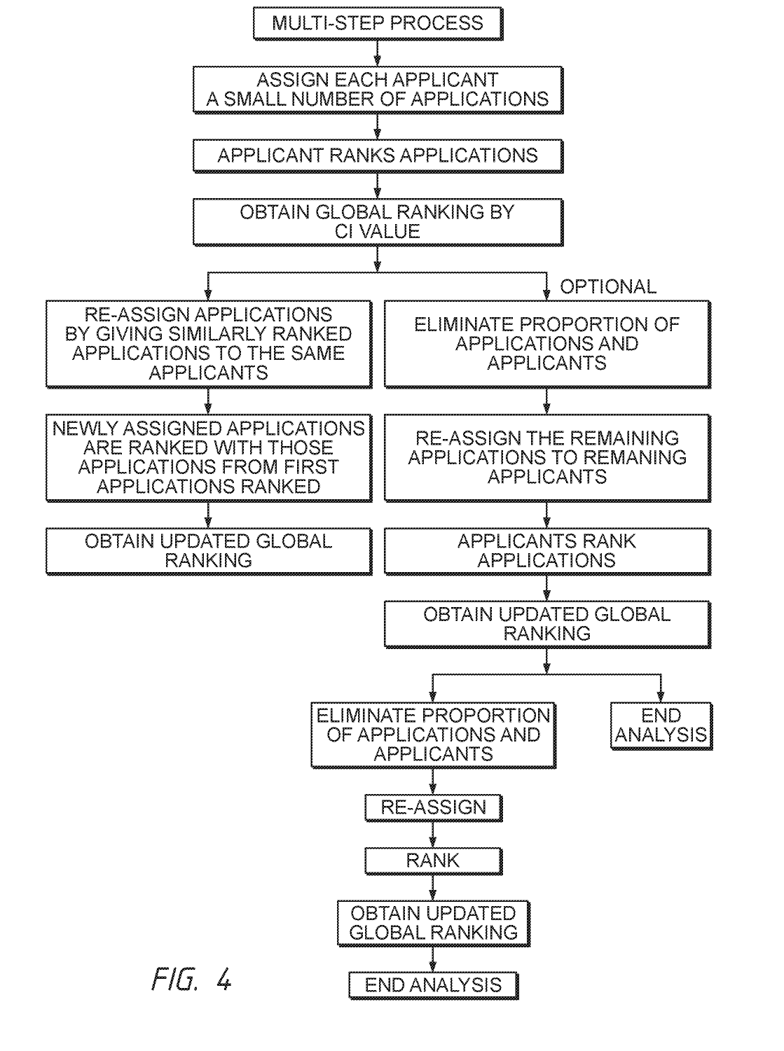

After either the deterministic step or the stochastic optimization step, the new global ranking is obtained. The administrator can stop and accept the global ranking as the final ranking or continue through further steps, as illustrated in FIG. 4.

In one embodiment the reviewers will be asked to provide a score in addition to the rankings. The scores can be used to obtain even better global rankings. For example, the linear combination of the global rankings can be used along with the average scores to determine the final ranks. Different weights in the linear combination can be used to attempt to improve the performance of the global ranking.

Additionally, a multiple cycle process can be used wherein the applicants engage in two separate review and rank periods. First, the applicant will be assigned a relatively small number of applications to rank (k). For example, the applicant's may be assigned 3 applications to rank. The global rankings of all the applications generated in the first step will be used to assign applications to the applicants in the next step. The applications with similar ranks will be assigned to the same applicants with higher probabilities in the random assignment process. It is in this manner that the applications with similar quality will be more likely grouped together and compared in head-to-head comparisons in the second step to yield better final global rankings. The MBC score-based criterion will not work in this modified procedure, but CI based criterion still works. In the second step, each reviewer will be assigned a different set of applications than they have reviewed in the first step. The newly assigned applications would be ranked together with those they have reviewed in the first step. If in the second step, each applicant reviews I applications, then totally, each applicant will give a rank of k+I applications at the end of the second step, which will be used to produce the updated global ranking of all the applications.

In yet another embodiment, the applications in the multiple cycle process will be culled down after the first step. Thus, eliminating a proportion of applications that can be safely considered as not very competitive using the global ranking generated in the first step. In this manner a large number of applications can be evaluated in an extremely efficient manner. For example, using this multiple step approach, a national wide competition with thousands of participants can be handled. The proportion of applications to be selected to advance to the next step can be adjusted by the administrator. For example, the bottom 50% of applications could be rejected after the first step review. This step can be repeated to eliminate more applications until a desired number of applications is selected. The multi-step process will generate higher quality reviews while minimizing the work for each reviewer. For example, if there are 100 applicants submitting 100 applications to a particular program and target funding rate is 15%, the prior art approach (solely based on MBC score based global ranking) would require the reviewer to rank a minimal of 7 applications. This is due to the inaccuracy of the MBC based global ranking system when reviewing a lower number of applications. Ultimately, this results in 700 reviews. In the multi-step approach 100 applicants can be assigned three applications in the first step. In the second step, only the top 50 applications are left to review, therefore, 50 applicants are assigned 3 more applications. After this step, the administrator has the option of a third step, where only the top 25 applications (and therefore 25 applicants) review 2 more applications. The top 25 applicants will have reviewed 8 applications each over the course of the steps. But they are more willing to do so given that they have made the cut. In the scenario where there are only two steps, the total number of reviews is 450. In the three-step scenario, the total number of reviews is 500. In either case, the number of reviews is substantially lower than the 700 required by the MBC based global ranking method. The benefit of fewer reviews is lower cost and a savings of time. However, this also improves the chance of the applicants completing the reviews and results in a more accurate final ranking.

It is worth noting that with CIGR, it is not necessary that each applicant is assigned with the same number of applications. In case that applicants are assigned different number of applications to review, to obtain the optimal CI values between a global ranking and individual rankings, one should not start with the ranking obtained using MBC score (it will not work in this case). Instead, the optimization can starts from a random ranking and let the Monte Carlo optimization procedure to find the optimal global ranking.

The preceding description contains significant detail regarding the novel aspects of the present invention. It should not be construed, however, as limiting the scope of the invention but rather as providing illustrations of the preferred embodiments of the invention. As an example, different embodiments of the method include additional steps that allow the administrator to cull results after the first or second step before compiling a final global ranking.

Having described my invention, I claim:

1. A computer-implemented method in a server system for evaluating a number of submissions provided by a number of applicants, comprising the steps of:
uploading said number of submissions to a central server in said server system,
grouping said plurality of submissions into a plurality of subgroups of m submissions,
assigning a subgroup of m submissions to an applicant until all of said subgroups are assigned,
allowing each of said number of applicants to rank each of said subgroups of m submissions, wherein said submissions are ranked from best to worst within said subgroup,
assigning an MBC score to a submission, wherein said MBC score is based on said rank of said submission within said subgroups that said submission was contained in,
calculating an initial global ranking based on said MBC score of each of said submissions,
calculating a CI value based on an agreement of said initial global ranking with each applicant's individual rankings of a plurality of pairs of said submissions,
switching a certain pair of said submissions to achieve the greatest increase in said CI value when said CI value is initially less than 1.0,
recalculating said CI value after switching said certain pair of said submissions to determine if said CI value has achieved a value of 1.0, and
repeating said step of switching another certain pair of said submissions to achieve the greatest increase in said CI value and recalculating said CI value after said switching step until said CI value is as close to 1.0 as possible.

2. The computer-implemented method of claim 1, wherein said number of applicants is equal to said plurality of subgroups.

3. The computer-implemented method of claim 1, wherein said submissions include a set of information having listed conflicts of interest.

4. The computer-implemented method of claim 3, further comprising the step of ensuring that none of said m submissions assigned to said applicant present a conflict of interest or belong to said applicant.

5. The computer-implemented method of claim 1, further comprising the step of ensuring that said subgroup of m submissions are different from one another.

6. The computer-implemented method of claim 1, further comprising the step of rewarding said applicants for accurately ranking said submissions.

7. A computer-implemented method in a server system for evaluating an x number of submissions provided by a number of applicants, comprising the steps of:
uploading said number of submissions to a central server in said server system,
grouping said plurality of submissions into a plurality of subgroups of m submissions,
assigning a subgroup of m submissions to an applicant until all of said subgroups are assigned,
allowing each of said number of applicants to rank each of said subgroups of m submissions, wherein said submissions are ranked from best to worst within said subgroup,
assigning an MBC score to a submission, wherein said MBC score is based on said rank of said submission within said subgroups that said submission was contained in,
calculating an initial global ranking based on said MBC score of each of said submissions,
calculating a CI value based on an agreement of said initial global ranking with each applicant's individual rankings of a plurality of pairs of said submissions,
switching a random pair of said submissions to achieve a new position of said random pair when said CI value is initially less than 1.0,
recalculating said CI value after switching said random pair of said submissions to determine if said CI value increased,
accepting said new position of said random pair if said CI value increased,
rejecting said new position of said random pair if said CI value decreased,
repeating said steps of switching a random pair of said submissions, recalculating said CI value and accepting or rejecting said new position based on said CI value, until said CI value is as close to 1.0 as possible.

8. The computer-implemented method of claim 7, wherein said number of applicants is equal to said plurality of subgroups.

9. The computer-implemented method of claim 7, wherein said submissions include information relating to conflicts of interest.

10. The computer-implemented method of claim 9, further comprising the step of ensuring that none of said m submissions assigned to said applicant present a conflict of interest or belong to said applicant.

11. The computer-implemented method of claim 7, further comprising the step of ensuring that said subgroup of m submissions are different from one another.

12. The computer-implemented method of claim 7, further comprising the step of rewarding said applicants for accurately ranking said submissions.

13. A computer-implemented method in a server system for evaluating a number of submissions provided by a number of applicants, comprising the steps of:
uploading said number of submissions to a central server in said server system,
grouping all of said plurality of submissions into a plurality of subgroups of k submissions,
assigning a subgroup of k submissions to an applicant until all of said subgroups are assigned,
allowing each of said number of applicants to rank each of said subgroups of k submissions, wherein said submissions are ranked from best to worst within said subgroup,
assigning an MBC score to a submission, wherein said MBC score is based on said rank of said submission within said subgroups that said submission was contained in,
calculating an initial global ranking based on said MBC score of each of said submissions,
grouping said plurality of submissions into a second plurality of subgroups of I submissions, wherein each of said subgroup of I submission has a higher probability of including submissions of similar ranks,
assigning a second subgroup of I submissions to said applicants until all of said second subgroups are assigned,
allowing said number of applicants to rank each of said second subgroups of I submissions, wherein said submissions are ranked from best to worst within said second subgroup,
assigning an MBC score to said submissions, and
calculating a second global ranking based on said MBC score of each of said submissions.

14. The computer-implemented method of claim 13, further comprising the step of eliminating a certain portion of submissions after said step of calculating an initial global ranking, and wherein said step of grouping said plurality of submissions only includes a remaining portion of submissions.

15. The computer-implemented method of claim 14, wherein said certain portion of submissions eliminated is 50% of said plurality of submissions.

16. The computer-implemented method of claim 14, further comprising the steps of:
eliminating a certain portion of submissions within said second subgroup,
grouping said plurality of submissions into a third plurality of subgroups of J submissions,
assigning a third subgroup of J submissions to said applicants until all of said third subgroups are assigned,
allowing each of said number of applicants to rank each of said third subgroups of J submissions, wherein said submissions are ranked from best to worst within said third subgroup,
assigning an MBC score to said submission, wherein said MBC score is based on said rank of said submission within said third subgroups that said submission was contained in, and
calculating a third global ranking based on said MBC score of each of said submissions.

17. The computer-implemented method of claim 14, wherein after the step of eliminating said portion of submissions, said applicants remaining are only those with submissions remaining.

18. The computer-implemented method of claim 13, wherein said submissions include a set of information having listed conflicts of interest.

19. The computer-implemented method of claim 18, further comprising the step of ensuring that none of said submissions assigned to an applicant present a conflict of interest or belong to said applicant.

20. The computer-implemented method of claim 13, further comprising the step of rewarding said applicants for accurately ranking said submissions.
